(19) United States
(12) Patent Application Publication
(10) Pub. No.: US 2007/0132919 A1
(43) Pub. Date: Jun. 14, 2007

(54) Backlight module having reflective polarizer sheet

(75) Inventors: Yu-Ju Hsu, Miao-Li (TW); Yung-Chiang Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/638,336

(22) Filed: Dec. 12, 2006

(30) Foreign Application Priority Data
Dec. 12, 2005 (CN) 200510102369.4

(51) Int. Cl. G02F 1/1335

(52) U.S. Cl. 349/96

(57) ABSTRACT

An exemplary backlight module (1) includes a reflective polarizer sheet (10), a diffusing sheet (11), and a reflective sheet (14). The reflective polarizer sheet includes a light incident surface (102), a light emitting surface (104) opposite to the light incident surface, and a plurality of prism structures (106) at the light emitting surface. The diffusing sheet is adjacent to the light incident surface of the reflective polarizer sheet. The reflective sheet is below the diffusing sheet. The backlight module has a high brightness and an improved light utilization ratio with a low cost and a reduced thickness.

### FIELD OF THE INVENTION

The present invention relates to backlight modules such as those used in liquid crystal displays (LCDs), and more particularly to a backlight module having a reflective polarizer sheet.

### GENERAL BACKGROUND

Liquid crystal displays (LCDs) are commonly used as display devices for compact electronic apparatuses, because they not only provide good quality images with little power but are also very thin. The liquid crystal molecules in a liquid crystal display do not emit any light themselves. The liquid crystal molecules have to be lit by a light source so as to clearly and sharply display text and images. Thus, a backlight module for an LCD is generally needed.

FIG. 6 is a schematic, exploded, side view of a conventional backlight module 7. The backlight module 7 includes a reflective polarizer sheet 70, a brightness enhancement sheet 72, a diffusing sheet 73, a light guide plate (LGP) 74, and a reflective sheet 76 disposed in that order from top to bottom. The backlight module 7 further includes a light source 78 disposed adjacent to a side edge of the light guide plate 74.

FIG. 7 is a schematic, enlarged, abbreviated, side cross-sectional view of the reflective polarizer sheet 70. The reflective polarizer sheet 70 includes a plurality of alternately stacked layers of transparent material (not labeled), a light incident surface 702, and a smooth light emitting surface 704 opposite to the light incident surface 702. The reflective polarizer sheet 70 generally needs to cooperate with the brightness enhancement sheet 72 in order to provide improved brightness for the backlight module 7. However, the brightness enhancement sheet 72 is typically expensive. Therefore the backlight module 7 is costly, and it is difficult to configure the backlight module 7 to be thin.

What is needed, therefore, is a backlight module that can overcome the above-described deficiencies.

### SUMMARY

An exemplary backlight module includes a reflective polarizer sheet, a diffusing sheet, and a reflective sheet. The reflective polarizer sheet includes a light incident surface, a light emitting surface opposite to the light incident surface, and a plurality of prism structures at the light emitting surface. The diffusing sheet is adjacent to the light incident surface of the reflective polarizer sheet. The reflective sheet is below the diffusing sheet.

Other advantages and novel features will become more apparent from the following detailed description when taken in conjunction with the accompanying drawings.

### BRIEF DESCRIPTION OF THE DRAWINGS

FIG. 1 is a schematic, exploded, side view of a backlight module according to a first embodiment of the present invention.

FIG. 2 is a schematic, enlarged, abbreviated, side cross-sectional view of a reflective polarizer sheet of the backlight module of FIG. 1.

FIG. 3 is a side cross-sectional view of part of a reflective polarizer sheet according to a second embodiment of the present invention.

FIG. 4 is a side cross-sectional view of part of a reflective polarizer sheet according to a third embodiment of the present invention.

FIG. 5 is a schematic, abbreviated, side cross-sectional view of a reflective polarizer sheet according to a fourth embodiment of the present invention.

FIG. 6 is a schematic, exploded, side view of a conventional backlight module.

FIG. 7 is a schematic, enlarged, abbreviated, side cross-sectional view of a reflective polarizer sheet of the backlight module of FIG. 6.

### DETAILED DESCRIPTION OF PREFERRED EMBODIMENTS

Reference will now be made to the drawings to describe the preferred embodiments in detail.

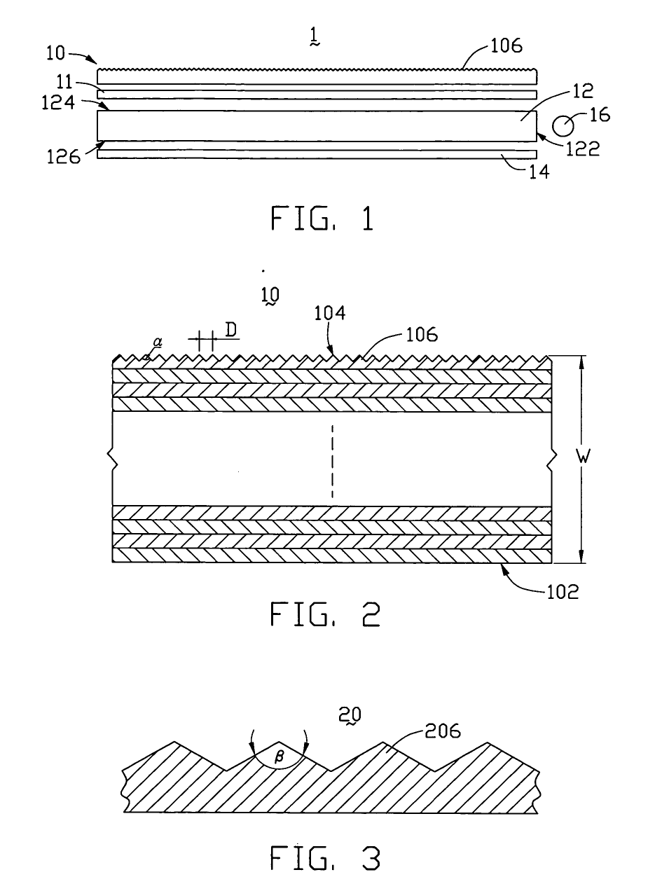

FIG. 1 is a schematic, exploded, side view of a backlight module according to a first embodiment of the present invention. The backlight module 1 includes a reflective polarizer sheet 10, a diffusing sheet 1, a light guide plate 12, and a reflective sheet 14 disposed in that order from top to bottom. The light guide plate 12 includes a side surface 122, a top surface 124 adjacent to the side surface 122 and facing the diffusing sheet 11, and a bottom surface 126 opposite to the top surface 124. The backlight module 1 further includes a light source 16 disposed adjacent to the side surface 122 of the light guide plate 12.

FIG. 2 is a schematic, enlarged, abbreviated, side cross-sectional view of the reflective polarizer sheet 10. The reflective polarizer sheet 10 is formed by a plurality of alternately stacked layers of transparent material (not labeled), and includes a smooth light incident surface 102 and a light emitting surface 104 opposite to the light incident surface 102. A distance W between the light incident surface 102 and the light emitting surface 104 is approximately 132 μm. The light emitting surface 104 includes a plurality of prism structures 106. The prism structures 106 are continuous and parallel to each other. Each prism structure 106 has a triangular cross-section, which includes an apex angle a that is a right angle. A pitch D between apices of two adjacent prism structures 106 is approximately 50 μm. The reflective polarizer sheet 10 can be made from materials with a birefringence characteristic. For example, the alternately stacked layers can be made of polyethylene naphthalate (PEN), and 70-naphthalate/30-terephthalate copolyester (a kind of coPEN).

In operation, unpolarized light beams emitted from the light source 16 enter the light guide plate 12 through the side surface 122. One portion of the light beams emit out of the light guide plate 12 through the top surface 124 and propagate to the diffusing sheet 11. These light beams are diffused by a plurality of diffusing particles (not shown) of the diff-using sheet 11, and propagate to the reflective polarizer sheet 10. Another portion of the light beams emit out of the light guide plate 12 through the bottom surface 126, and are reflected back into the light guide plate 12 by the reflective sheet 14. These light beams finally reach the reflective polarizer sheet 10 after being diffused by the diffusing particles of the diffusing sheet 11.

Unpolarized light beams include both s-polarization components and p-polarization components. When unpolarized light beams propagate to the reflective polarizer sheet 10, p-polarization components are transmitted through the reflective polarizer sheet 10 and pass through the prism structures 106, and s-polarization components are reflected back. By cooperation of the diffusing sheet 11 and the reflective sheet 14, some of the reflected s-polarization components are converted to p-polarization components, which are transmitted through the reflective polarizer sheet 10 and pass through the prism structures 106. By this process, most of the unpolarized light beams can be transmitted through the reflective polarizer sheet 10 after the s-polarization components thereof are reflected one or more times and converted by cooperation between the diffusing sheet 11 and the reflective sheet 14. This enables a rate of light utilization of the backlight module 1 to be improved. Furthermore, the prism structure 106 of the reflective polarizer sheet 10 can refract light beams, such that light beams which would otherwise be emitted from the light emitting surface 104 at large angles are in fact emitted at smaller angles. This has the effect of increasing an amount of light beams that are emitted with an improved brightness. That is, the reflective polarizer sheet 10 can take the place of a prism sheet that is normally used in a conventional backlight module, while still providing improved brightness for the backlight module 1. Thus, the backlight module 1 has a high brightness and an improved light utilization ratio with a low cost and a reduced thickness.

FIG. 3 is a side cross-sectional view of part of a reflective polarizer sheet according to a second embodiment of the present invention. The reflective polarizer sheet 20 is substantially the same as the reflective polarizer sheet 10, except that the reflective polarizer sheet 20 has a plurality of prism structures 206. The prism structures 206 are continuous and parallel to each other. An apex angle β of each prism structure 206 is an obtuse angle, which is preferably 120 degrees.

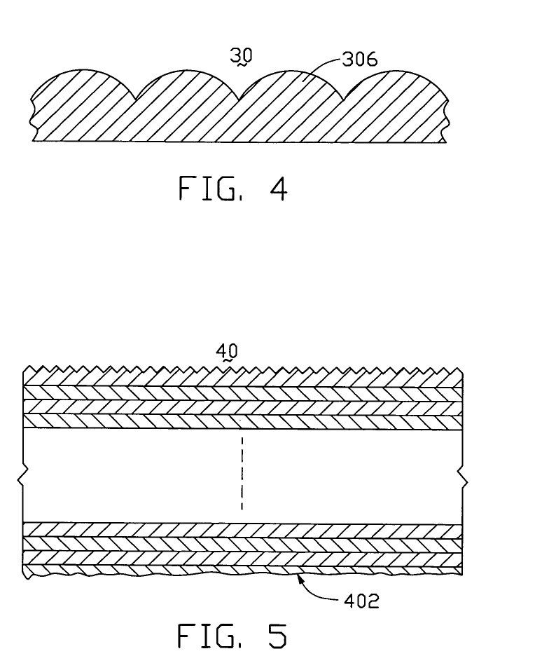

FIG. 4 is a side cross-sectional view of part of a reflective polarizer sheet according to a third embodiment of the present invention. The reflective polarizer sheet 30 is substantially the same as the reflective polarizer sheet 10, except that the reflective polarizer sheet 30 has a plurality of prism structure 306. The prism structures 306 are continuous and parallel to each other. Each prism structures 306 defines a curved cross-section. The cross-section may for example be arcuate or arc-shaped.

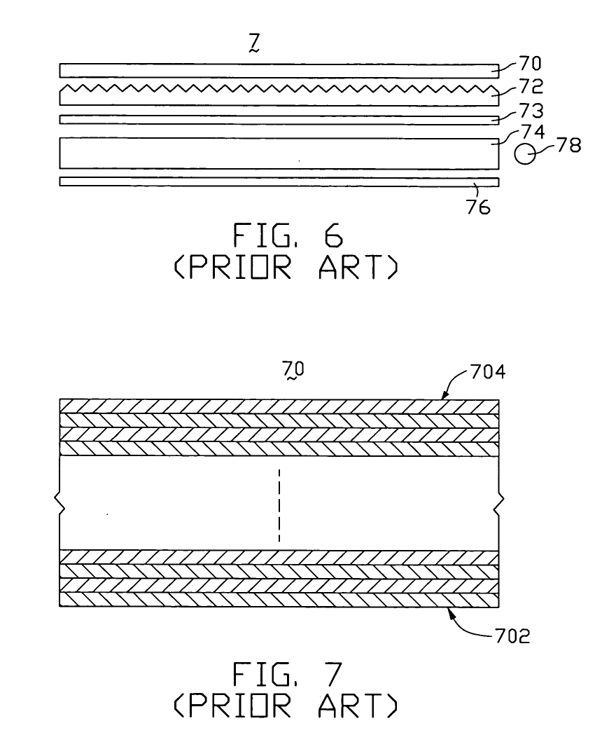

FIG. 5 is a schematic, abbreviated, side cross-sectional view of a reflective polarizer sheet according to a fourth embodiment of the present invention. The reflective polarizer sheet 40 is substantially the same as the reflective polarizer sheet 10, except that the reflective polarizer sheet 40 has a rough light incident surface 402. The rough light incident surface 402 can be achieved by a grinding process, or by coating a plurality of diffusing particles on a base surface of the reflective polarizer sheet 40.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A reflective polarizer sheet, comprising:
a light incident surface; and
a light emitting surface opposite to the light incident surface;
wherein the light emitting surface comprises a plurality of prism structures.

2. The reflective polarizer sheet in claim 1, further comprising a plurality of alternately stacked transparent layers between the light incident surface and the light emitting surface.

3. The reflective polarizer sheet in claim 1, wherein the prism structures are parallel to each other.

4. The reflective polarizer sheet in claim 1, wherein a distance between the light incident surface and the light emitting surface is approximately 132 μm.

5. The reflective polarizer sheet in claim 1, wherein each prism structure has a triangular cross-section.

6. The reflective polarizer sheet in claim 5, wherein an apex angle of the triangular cross-section is a right angle.

7. The reflective polarizer sheet in claim 5, wherein an apex angle of the triangular cross-section is an obtuse angle

8. The reflective polarizer sheet in claim 7, wherein the obtuse angle is approximately 120 degrees.

9. The reflective polarizer sheet in claim 1, wherein each prism structure has a curved cross-section.

10. The reflective polarizer sheet in claim 1, wherein a pitch between apices of two adjacent prism structures is approximately 50 m.

11. The reflective polarizer sheet in claim 1, wherein the light incident surface is smooth.

12. The reflective polarizer sheet in claim 1, wherein the light incident surface is rough.

13. The reflective polarizer sheet in claim 1, wherein material thereof has a birefringence characteristic.

14. The reflective polarizer sheet in claim 2, wherein the alternately stacked transparent layers respectively comprise 70-naphthalate/30-terephthalate copolyester (coPEN) and polyethylene naphthalate (PEN).

15. A backlight module, comprising:
a reflective polarizer sheet, comprising:
a light incident surface;
a light emitting surface opposite to the light incident surface; and
a plurality of prism structures at the light emitting surface;
a diffusing sheet adjacent to the light incident surface of the reflective polarizer sheet; and
a reflective sheet below the diffusing sheet.

16. The backlight module in claim 15, furthering comprising a light guide plate between the diffusing sheet and the reflective sheet.

17. The backlight module in claim 15, wherein the prism structures are parallel to each other.

18. The backlight module in claim 15, wherein each prism structure has a triangular cross section.
